(19) United States
(12) Patent Application Publication
(10) Pub. No.: US 2023/0090354 A1
(43) Pub. Date: Mar. 23, 2023

(54) TOWED WINGED AGRICULTURAL IMPLEMENT WITH FORWARDLY FOLDING WING SECTIONS

(71) Applicant: GRUNTHAL WELDING & SUPPLIES LTD., GRUNTHAL (CA)

(72) Inventors: LEONARD JAKIE HIEBERT, GRUNTHAL (CA); JOSHUA WAYNE MARTENS, GRUNTHAL (CA); DOUGLAS KEVIN REDEKOP, GRUNTHAL (CA); DANIEL DAVID HIEBERT, GRUNTHAL (CA)

(21) Appl. No.: 17/712,281

(22) Filed: Apr. 4, 2022

Related U.S. Application Data
(60) Provisional application No. 63/246,369, filed on Sep. 21, 2021.

(51) Int. Cl. A01B 73/06; A01B 63/16; A01B 49/06

(52) U.S. Cl. CPC A01B 73/065; A01B 63/16; A01B 49/06

(57) ABSTRACT

A towed winged agricultural implement comprises a center frame section arranged for mounting behind a towing vehicle relative to a forward direction of travel and a pair of wing frame sections having respective inner ends which are pivotally coupled at transversely opposite sides of the center frame section. The wing frame sections are movable relative to the center frame section between a working configuration extending forwardly and transversely outwardly in opposite directions from the center frame section, and a transport configuration extending forwardly from the center frame section to be parallel to the forward direction of travel and located adjacent the sides of the towing vehicle.

This application claims the benefit under 35 U.S.C. 119(e) of U.S. Provisional app. Ser. No. 63/246,369 filed Sep. 21, 2021.

### FIELD OF THE INVENTION

The present invention relates generally to a towed winged agricultural implement with forwardly folding wing sections, and more particularly to such an implement in which the wing sections are configured to be disposed alongside the towing vehicle.

### BACKGROUND

There exist a multitude of towed or drawn agricultural implements formed from a plurality of sections, at least one of which is located behind the towing vehicle relative to a forward direction of travel thereof and at least two of which are located laterally outwardly or which extend laterally past sides of the towing vehicle. Such outward sections are typically foldable inwardly so as to reduce an overall width of the implement for transport, and thus are often referred to in industry as wing sections.

It may be difficult for an operator of the towing vehicle to see outer ends of the wing sections when transversely or laterally outwardly extended in a working configuration of the implement, which in turn may limit maneuverability of the vehicle with the implement. Also, in typical configurations where the wing sections extend substantially laterally outwardly, so as to be substantially collinear or parallel to a center section located behind the towing vehicle, a center of mass of the coupled configuration of towing vehicle and implement is closer to a rear end of the towing vehicle than to a front end thereof, and in some cases behind the a rear rotational axis of traction elements of the towing vehicle, which usually reduces traction of the towing vehicle.

### SUMMARY OF THE INVENTION

It is an object of the invention to provide a winged agricultural implement for towing in a forward working direction by a towing vehicle.

Generally speaking, the towing vehicle has a frame configured for movement across a ground surface. The frame has opposite front and rear ends along a longitudinal axis parallel to the forward working direction, and the towing vehicle has transversely opposite sides. Also, the towing vehicle has front and rear pairs of traction elements rotatably supported on the frame and rotatable around longitudinally spaced front and rear rotational axes of the towing vehicle located in front of the rear end of the frame for supporting the frame in movement across the ground surface.

According to an aspect of the invention, the winged agricultural implement comprises:

a center frame section arranged for mounting to the towing vehicle at the rear end thereof;

a pair of wing frame sections having respective inner ends which are pivotally coupled at transversely opposite sides of the center frame section; and

wherein the wing frame sections are movable relative to the center frame section between a working configuration extending forwardly and transversely outwardly in opposite directions from the center frame section, and a transport configuration extending forwardly from the center frame section to be parallel to the forward working direction and located adjacent the sides of the towing vehicle.

This arrangement of winged agricultural implement may be used with a towing vehicle, such as a tractor, that is smaller and has front wheel assist instead of a larger, more powerful unit with four wheel drive. Also, this arrangement of implement acts to transfer weight of the coupled configuration of towing vehicle with implement towards the front rotational axis of the vehicle, enhancing maneuverability. Furthermore, forward folding of the wing sections alongside the towing vehicle, so as to lead the center frame section, acts to reduce length of the implement behind the towing vehicle during transport, which provides an opportunity to tow another implement or piece of equipment. Yet further, the wing sections located horizontally to the side of the towing vehicle may increase visibility to an operator of the towing vehicle, especially in the working configuration.

Preferably, the center frame section is configured to span substantially a full width of the towing vehicle from one of the sides thereof to the other one thereof. As such, the transversely opposite sides of the center frame section are arranged to be located at or slightly outwardly of the sides of the towing vehicle.

In at least one arrangement, the wing frame sections when in the working configuration extend forwardly past the rear rotational axis of the towing vehicle.

In at least one arrangement, the implement further includes ground-engaging wheels rotatably coupled at respective distal ends of the wing frame sections that are opposite the respective inner ends thereof. This helps to support the wing frame sections in the working configuration during movement in the forward working direction.

In at least one arrangement, the ground-engaging wheels are supported for rotation around respective rotational axes arranged parallel to and rearwardly of the front rotational axis of the towing vehicle when the implement is arranged in the working configuration.

In at least one such arrangement, the wing frame sections each comprise a beam spanning between the respective inner and distal ends, and a corresponding one of the ground-engaging wheels is supported for rotation at a forwardly spaced location from the beam.

In at least one arrangement, the ground-engaging wheels are supported for pivotal movement about respective vertical pivot axes. Thus the wheels can rollably engage the ground surface not only while the towing vehicle is turning but also in both the working and transport configurations.

In at least one arrangement, the wing frame sections when in the transport configuration are spaced from the sides of the towing vehicle. This affords space for an operator to access the towing vehicle.

Preferably, the wing frame sections are pivotally movable relative to the center frame section about respective vertical pivot axes.

Preferably, the implement further includes first interlocking members on the respective inner ends of the wing frame sections configured for mating engagement, in the working configuration, with second interlocking members on the sides of the center frame section, and wherein the first interlocking members carry respective keeper pins and wherein the center frame section carries pivotal latch dogs configured to retain the keeper pins in the working configuration to secure the first interlocking members with the second interlocking members.

In at least one arrangement, each first interlocking member is a wedge-shaped interlocking member with upwardly and downwardly facing walls.

In at least one arrangement, each second interlocking member comprises a receptacle with a V-shaped interior having vertically opposite inside walls.

In at least one arrangement, the implement further includes a ground-engaging wheel assembly rotatably coupled to the center frame section.

Preferably, the ground-engaging wheel assembly comprises at least one wheel supported for rotation at a readwardly spaced location from the center frame section. As such, the ground-engaging wheel assembly is in a trailing position relative to the center frame section.

In at least one arrangement, the ground-engaging wheel assembly is configured to be raised and lowered relative to the center frame section. Thus the ground-engaging wheel assembly can be positioned to shift a center of mass of the coupled configuration of towing vehicle and implement forwardly to improve traction of the towing vehicle.

In at least one arrangement, the implement further includes a vehicle mounting member supported on the center frame section and configured for coupling to a three-point hitch.

In one arrangement, the implement is a liquid fertilizer applicator configured for coupling to a fertilizer source by a hose trailing the implement. In such an arrangement, the center frame section supports a hose inlet configured for coupling to the hose at a height above a vehicle mounting member of the center frame section.

### BRIEF DESCRIPTION OF THE DRAWINGS

The invention will now be described in conjunction with the accompanying drawings in which:

FIGS. 1 and 2 are perspective views of an arrangement of winged agricultural implement according to the present invention, which is mounted to a tractor (schematically shown) acting as a towing vehicle, and shown in a working configuration;

FIG. 3 is a top plan view of the arrangement of FIG. 1 in the working configuration;

FIGS. 4 and 5 are perspective views of the arrangement of FIG. 1 in a transport configuration;

FIG. 6 is a top plan view of the arrangement of FIG. 1 in the transport configuration;

FIGS. 7 and 8 are front and rear elevational views, respectively, showing the arrangement of FIG. 1 in the working configuration;

FIG. 9 is a side elevational view of the arrangement of FIG. 1 in the working configuration;

FIGS. 10 and 11 are close-up perspective and rear elevational views, respectively, showing an interlocking assembly of the arrangement of FIG. 1;

FIGS. 12 and 13 are front and rear elevational views, respectively, showing the arrangement of FIG. 1 in the transport configuration; and

FIG. 14 is a side elevational view of the arrangement of FIG. 1 in the transport configuration.

In the drawings like characters of reference indicate corresponding parts in the different figures.

### DETAILED DESCRIPTION

Referring to the accompanying figures, there is shown a winged agricultural implement 20 for towing in a forward working direction FW by a towing vehicle 1.

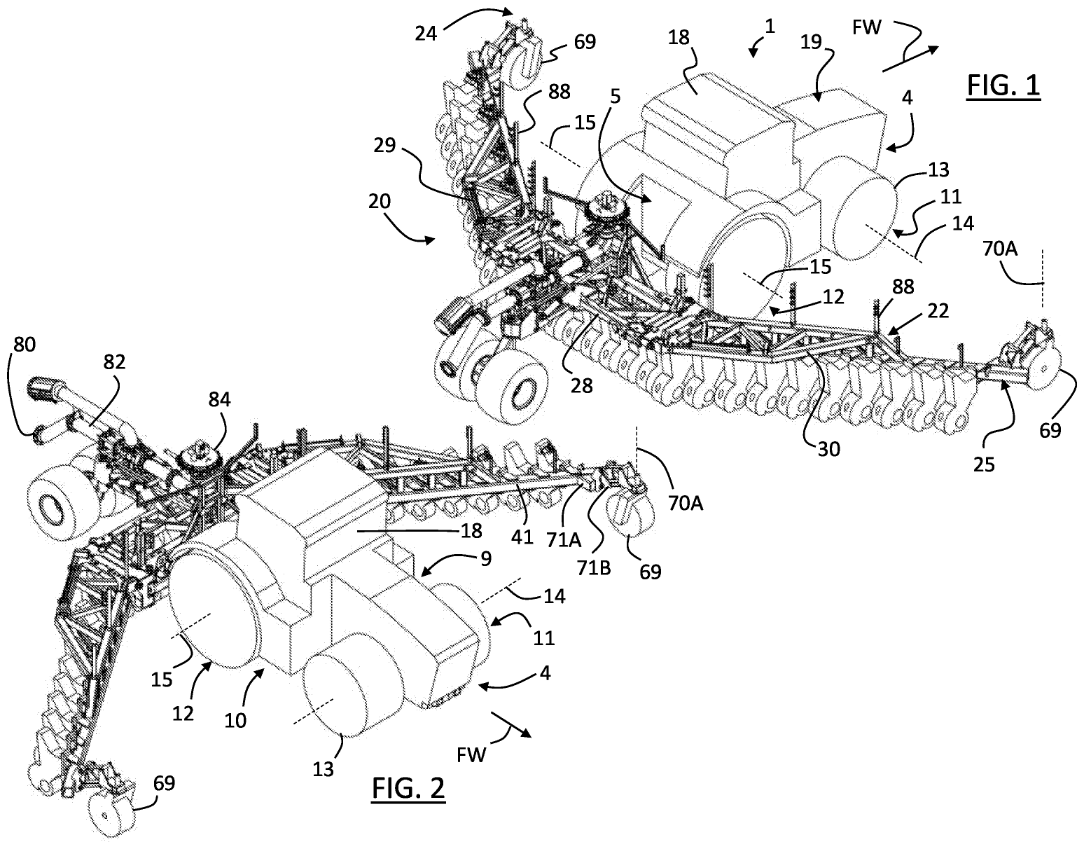

Generally speaking, and with reference to FIGS. 1-3, the towing vehicle 1, such as a tractor as shown in the figures, has a frame 2 configured for movement across a ground surface in a forward direction travel, which is the same as the forward working direction. The frame 2 has opposite front and rear ends 4, 5 arranged along a longitudinal axis 7 of the towing vehicle parallel to the forward working direction FW, and opposite sides 9, 10. Further, the towing vehicle 1 has front and rear pairs 11, 12 of traction elements 13, such as wheels, rotatably supported on the frame and rotatable around longitudinally spaced front and rear rotational axes 14, 15 of the towing vehicle located in front of the rear end 5 of the frame for supporting the frame in movement across the ground surface. Of course, the front rotational axis 14 is located in front of the rear rotational axis 15 which is in front of the rear end 5. Also, each one of the pair of traction elements 13 is located at the side of the towing vehicle. An outer width of each pair of traction elements may be greater than the width of the frame alone and body panels of the towing vehicle so as to define a width of the towing vehicle, which is true of the illustrated arrangement.

The towing vehicle 1 further includes a hitching member 17 at the rear end thereof, such as a three-point hitch, configured for receiving and coupling to an implement. Furthermore, the towing vehicle 1 includes an operator cab or cabin 18 supported on the frame 2 and configured for receiving a human operator and housing controls for operating the towing vehicle. In the case of a tractor, the operator cab 18 is disposed closer to the rear end 5 than to the front end 4. An engine 19 is mounted in front of the cabin 18 and operatively connected to two or more of the traction elements to propel the vehicle in the forward working direction FW.

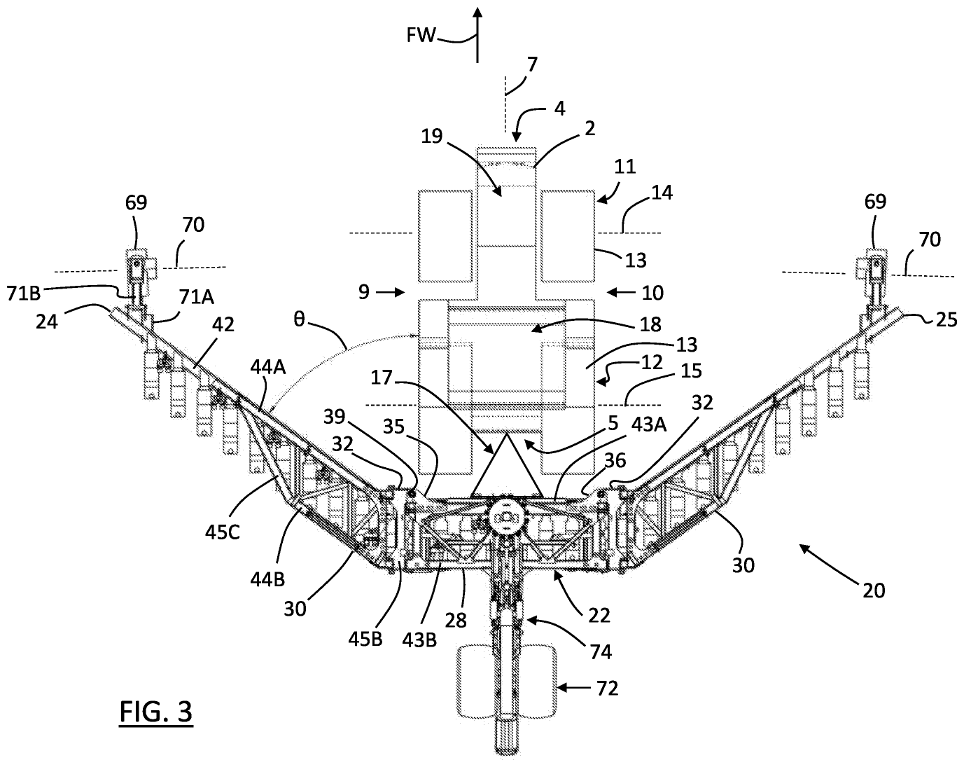

Turning now to the agricultural implement 20, and with reference to FIG. 3, the implement comprises a frame 22 configured for mounting to the towing vehicle 1 at the rear end 5 thereof. The frame 22 extends transversely of the towing vehicle 1 from one end 24 arranged on one side 9 of the towing vehicle 1 to another end 25 of the frame arranged on the opposite side 10 of the towing vehicle.

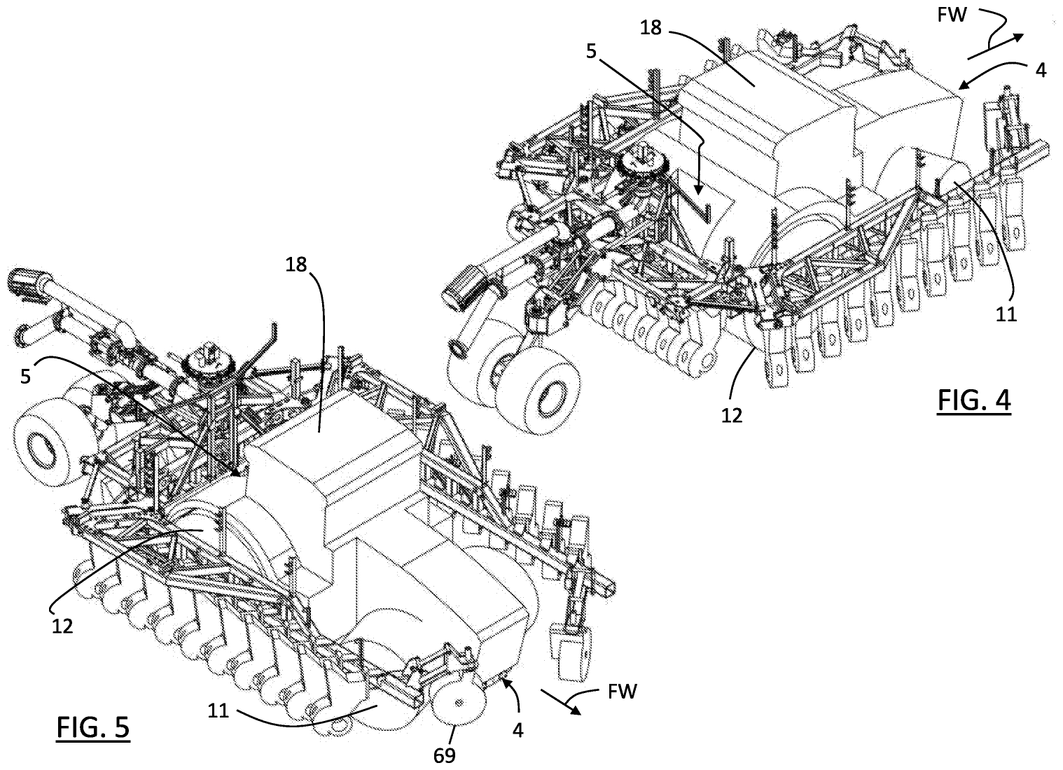

Since a width of the implement frame 22 is unsuitable for road transport, the frame 22 comprises a plurality of frame sections, at least one which (in this case, that indicated at 28) is arranged behind the towing vehicle 1 relative to the forward direction of travel FW and at least two of which (in this case, those indicated at 30) are located outwardly and on either side of the at least one of the bar sections behind the towing vehicle. The outward frame sections, in this case 30, are pivotally movable relative to one or more inwardly located frame sections, in this case a single section 28, between a working configuration, as shown for example in FIGS. 1-3, in which the outermost frame sections extend transversely outwardly and forwardly from the inwardly located frame section and a transport configuration, as shown in FIG. 4-6, in which the outermost frame sections extend substantially forwardly so as to be parallel to the forward direction of travel FW.

In other words, the implement 20 comprises a center frame section 28 arranged for mounting to the towing vehicle 1 at the rear end 5 thereof and a pair of wing frame sections 30. On the center frame section 28 there is supported a conventional vehicle mounting member 31 at a front of the section, which is configured for coupling to the hitching member 17, like a three-point hitch, of the towing vehicle 1. The wing frame sections 30 have respective inner ends 32 which are pivotally coupled at transversely opposite sides 35, 36 of the center frame section 28. The wing frame sections 30 are movable relative to the center frame section 28 between a working configuration extending forwardly and transversely outwardly in opposite directions from the center frame section 28, and a transport configuration extending forwardly from the center frame section 28 to be parallel to the forward working direction FW and located adjacent the sides 9, 10 of the towing vehicle. Thus in both the working and transport configurations, the wing frame sections 30 lead the center frame section 28 relative to the forward working direction or direction of travel FW.

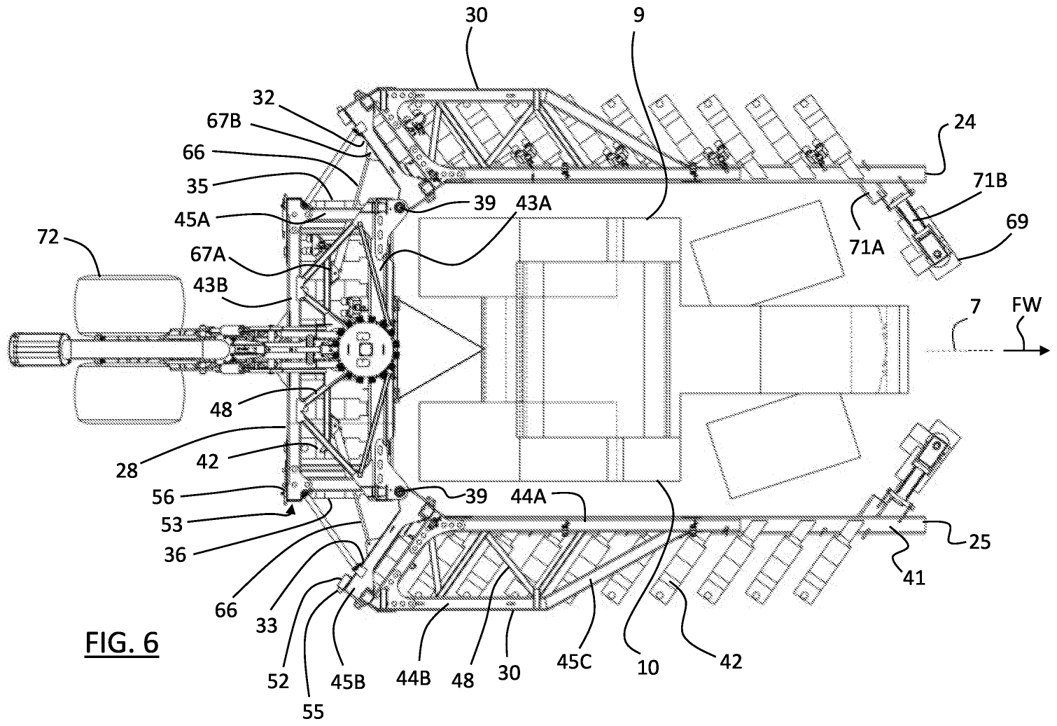

As shown more clearly in FIGS. 3 and 6, the center frame section 28 is configured to span substantially a full width of the towing vehicle 1 from one side 9 to the other side 10. As such, the transversely opposite sides 35, 36 of the center frame section 28 are arranged to be located at or slightly outwardly of the sides 9, 10 of the towing vehicle. In the illustrated arrangement, the center frame section 28 is slightly wider than the towing vehicle which acts to locate the inner ends 32 of the wing frame sections transversely outwardly of the towing vehicle to provide more clearance between same the towing vehicle in the transport configuration. Furthermore, respective pivot axes 39 of the pivotal movement of the wing frame section 30 relative to the center frame section 28 are thus located transversely outwardly of the towing vehicle 1, at front corners of the center frame section 28, to enable the wing frame sections to fold alongside the towing vehicle for transport.

The wing frame sections 30 span from the respective inner ends 32 located at or adjacent the center frame section 28 to respective distal ends, which are indicated at 24 and 25 and which are distal to the center frame section 28, and which are located forwardly of the rear rotational axis 15, notably in the working configuration, such that the wing frame sections extend forwardly past same. The center frame section 28 extends along a linear path between its transversely opposite sides 35, 36 and the wing frame sections 30 also extend along linear paths between their opposite ends 32 and 24 or 25.

The frame sections 28, 30 each comprise interconnected sets of upper and lower frame members. The upper frame members provide structural strength and support an interlocking assembly for securing the frame sections in fixed relation to each other in the working configuration, while the lower frame members act as tool bars for mounting soil working tools.

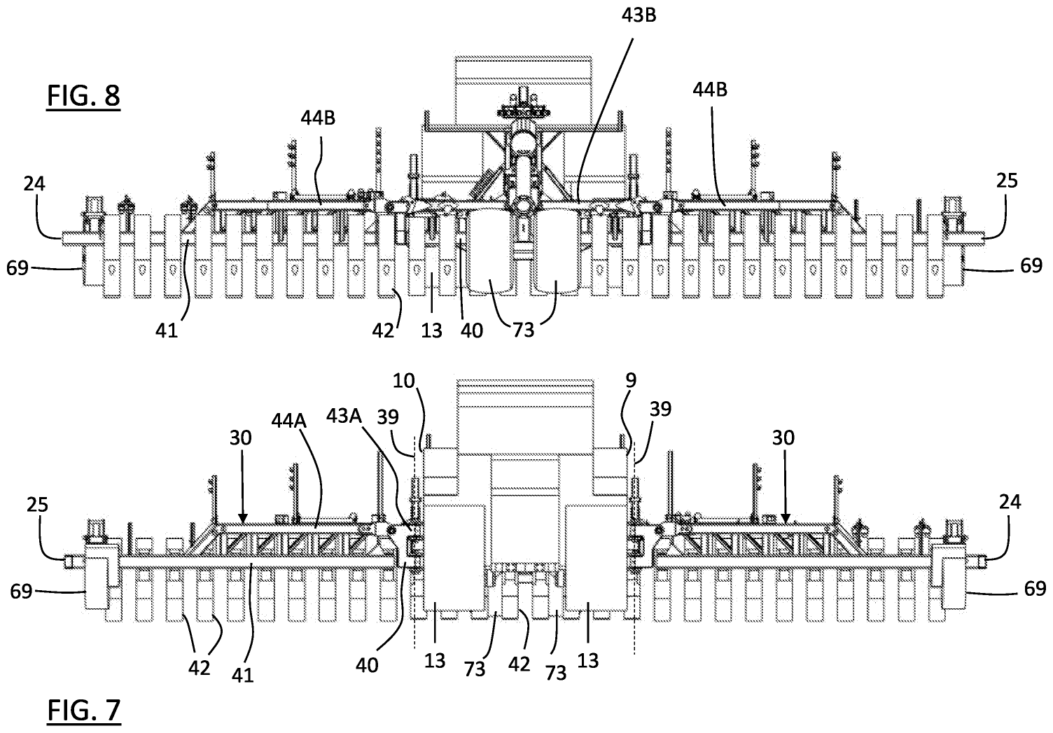

With reference to FIGS. 7 and 8, the lower frame members comprise a single beam 40, 41 at a front of the frame section and configured to support a plurality of plurality of tool members 42, such as cultivator discs, mounted at transversely spaced locations thereon and configured for working the soil.

With reference now additionally to FIGS. 3 and 6, the upper frame members comprise an assembly of longitudinally-spaced transversely-extending beams 43A and 43B and 44A and 44B, which are interconnected by transversely-spaced longitudinally-extending cross members 45A, 45B and 45C. The cross members 45A of the center frame section 28 are arranged at the ends of the transverse beams 43A, 43B of the center frame section so as to define the sides thereof.

Furthermore, the cross members 45A are substantially perpendicularly oriented to the transverse beams 43A, 43B. On the other hand, the cross members 45B and 45C of the respective wing frame section are arranged at the inner end 32 or 33 thereof and at an intermediary location between same and the distal end 24 or 25. Both cross-members 45B and 45C are oriented non-perpendicularly transversely to the transverse front and rear beams 44A and 44B of the wing frame section, but the intermediately arranged one 45C, which is considered an outer cross member, is oriented to extend more transversely than longitudinally as compared to the cross member 45B, which is considered an inner cross member, and which extends more longitudinally than transversely. Furthermore, the upper frame members also include a plurality of braces 48 spanning between pairs of other frame members of the upper assembly. There may be provided brace members 48 spanning between members of the upper and lower frame assemblies.

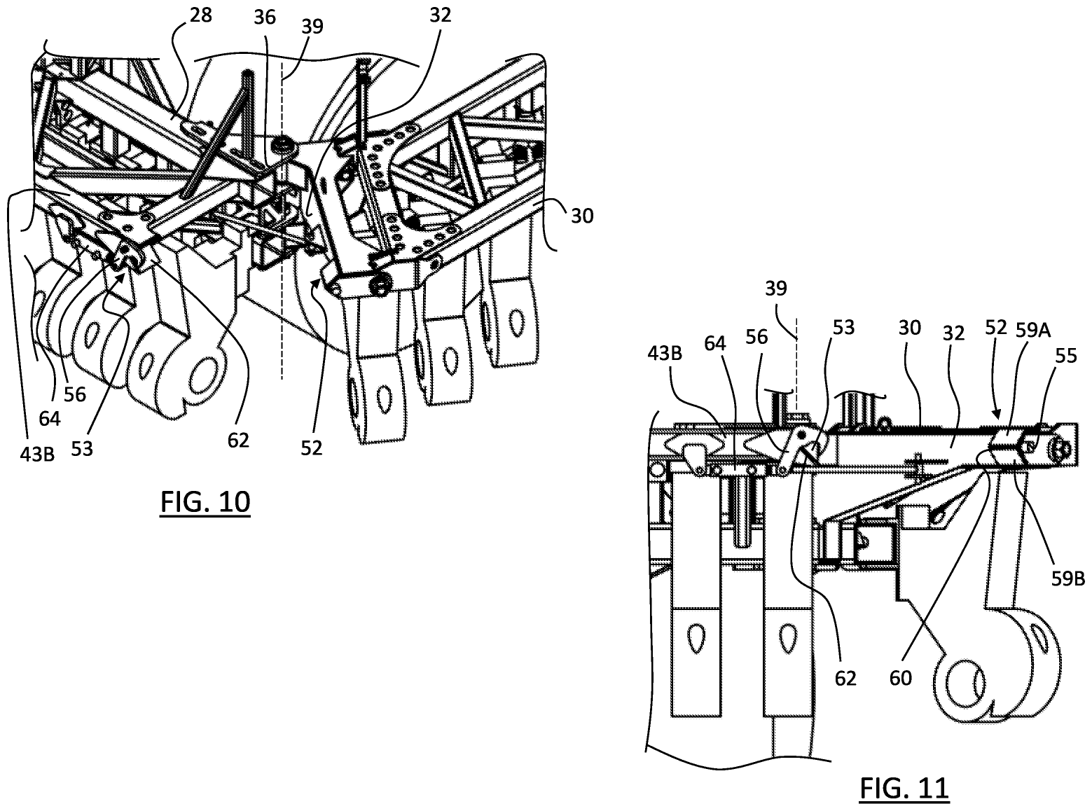

Referring to FIGS. 3, 10 and 11, the wing frame sections 30 are supported in the working configuration by abutment of the inner ends 32 with the sides 35, 36 of the center frame section 28. The inner ends 32 of the wing frame sections 30 are pivotally coupled at respective vertical pivot axes 39 located at a front of the center frame section 28, and there is provided an interlocking assembly comprising first and second interlocking members 52, 53 on rears of the wing frame sections 30 and the center frame section 28, respectively. The first and second interlocking members 52, 53 are configured for mating engagement in the working configuration to secure the frame sections in substantially fixed relation to each other. More specifically, the first interlocking 52 members are disposed on the respective inner ends 32 of the wing frame sections and the second interlocking members 53 are disposed on the sides 35, 36 of the center frame section (although in FIGS. 10 and 11 only one and the same side 36 is shown). The first interlocking members 52 on the wing frame sections 30 carry respective keeper pins 55, and the center frame section 28 carries pivotal latch dogs 56 on the opposite sides 35, 36 which are configured to retain the keeper pins in the working configuration to secure the first and second interlocking members in mating engagement. In this mating engagement, the interlocking members 52, 53 maintain the frame sections in fixed vertical relation to one another, while the latch dogs 56 cooperating with the keeper pins 55 maintain the frame sections in fixed transverse relation to each other.

As more clearly shown in FIGS. 10 and 11, the first interlocking members 52 are wedge-shaped with upwardly and downwardly facing walls 59A, 59B which meet at a tip 60. The second interlocking members 53 are V-shaped receptacles with vertically opposite inside walls 62 and no sidewalls. Thus the receptacles effectively form V-shaped grooves. Since the interlocking members 52, 53 are situated or disposed on the upper frame assembly of the various sections, which are arranged at a common height relative to the vehicle mounting member 28A of the implement, the walls of the interlocking members act as ramps to guide the wing frame sections into alignment with the center frame section so that the tool bars of the multiple sections lie in a common plane.

The latch dog 56 for each side 35, 36 of the center frame section 28 is mounted on a rear one of the transverse beams 43B and is actuated in pivotal movement, relative to the beam 43B, between open and closed positions for receiving and retaining the keeper pin, respectively, by a linear hydraulic cylinder actuator 64. The keeper pin 55 on the cooperating interlocking member of the adjacent wing frame section protrudes rearwardly so as to be presented for cooperation with the latch dog. Referring back to FIG. 6, in order to move between the working and transport configurations, the implement 20 includes a pair of linear actuators 66 in the form of hydraulic cylinders, one coupled between each adjacent pairing of center frame section 28 and wing frame section 30. The hydraulic cylinders 66 are mounted with their barrel ends 67A pivotally connected to the center frame section 28 and rod ends 67B pivotally connected to the corresponding wing frame section. The hydraulic cylinders 66 may operate for extension and retraction in unison so that pivotal movement of the wing frame sections 30 is symmetrical about the longitudinal axis 7 of the towing vehicle. Hydraulic pumps for delivering hydraulic fluid to the hydraulic cylinders may be driven via a power take off shaft of the towing vehicle especially when in the form of a tractor.

Referring back to FIG. 3, in the working configuration, the wing frame sections 30 of the illustrated arrangement of implement are arranged to extend forwardly and transversely outwardly at an angle θ between about 35 degrees and about 65 degrees relative to the forward working direction FW. In the illustrated arrangement, the prescribed angle of the wing frame sections in the working configuration is about 55 degrees to the forward working direction FW. This may maximize a width of the implement between opposite ends 24, 25 while providing for a center of mass of the coupled towing vehicle and implement which is situated sufficiently forwardly of the rear rotational axis 15 to provide suitable traction for towing. To support the implement 20 in movement across a ground surface, especially that which is uneven, the implement includes ground-engaging wheels 69 rotatably coupled at the respective distal ends 24, 25 of the wing frame sections. Thus the implement has laterally opposite wing-supporting ground-engaging wheels to support the wing frame sections 30 in the working configuration during movement in the forward working direction FW.

In the illustrated arrangement, the ground-engaging wheels 69 are supported for rotation around respective rotational axes 70 arranged parallel to and rearwardly of the front rotational axis 14 of the towing vehicle when the implement is arranged in the working configuration. The wheels 69 are not driven but are supported for pivotal movement relative to the mounting frame member, in this case the lower member 41, around a vertical pivot axis 70A. Furthermore, each ground-engaging wheel 69 is supported forwardly of the lower beam 41, such that the wheel is supported for rotation at a forwardly spaced location from the beam in leading relation thereto. More specifically, each wing-supporting wheel 69 is supported on a beam 71A which is transversely oriented to the lower beam 41, so as to extend forwardly and outwardly therefrom, such that in the working configuration the wheel 69 is located substantially forwardly of the wing frame section 30 and in the transport configuration it is clear of the towing vehicle 1 so that the wing sections 30 can be located as closely to the sides of the vehicle 1 as possible. Also, each wing-support wheel 69 is pivotally carried on the respective wing frame section 30, in that there is provided a linkage 71B configured to enable upward and downward movement of the wheel 69 relative to the beam 71A which is affixed to the lower beam 41 of the wing frame section 30. Thus, the wing-support wheels 69 can depend downwardly from the beam towards and into contact the ground surface, and they can turn side-to-side with the towing vehicle when the implement is in the working configuration and they can rollably engage the ground in the transport configuration, as will be better appreciated shortly.

The implement 20 also includes a ground-engaging wheel assembly 72 (schematically shown in select drawing figures) rotatably coupled to the center frame section 28. The assembly 72 comprises at least one wheel 73 supported for rotation at a readwardly spaced location from the center frame section 28. As such, the ground-engaging wheel assembly 72 is in a trailing position relative to the center frame section, so as to be a trailing central wheel assembly of the implement, by being supported rearwardly of a rearmost beam of the center frame section, in this case that at 43B. Furthermore, the ground-engaging wheel assembly 72 is configured to be raised and lowered relative to the center frame section 28. This is achieved by rotatably supporting the individual wheels 73 on a strut linkage 74 pivotally connected to the frame members 43B of the center frame section, and interconnecting a linear actuator 76 between the strut assembly and the assembly of frame members to actuate the upward and downward movement. Thus the ground-engaging wheel assembly 72 can be positioned into engagement with the ground to shift a center of mass of the coupled configuration of towing vehicle and implement forwardly to improve traction of the towing vehicle 1.

As more clearly shown in FIGS. 6, 12 and 13, the wing frame sections 30 when in the transport configuration are spaced from the sides 9, 10 of the towing vehicle. This affords space for an operator to access the towing vehicle 1 while the implement remains mounted thereto.

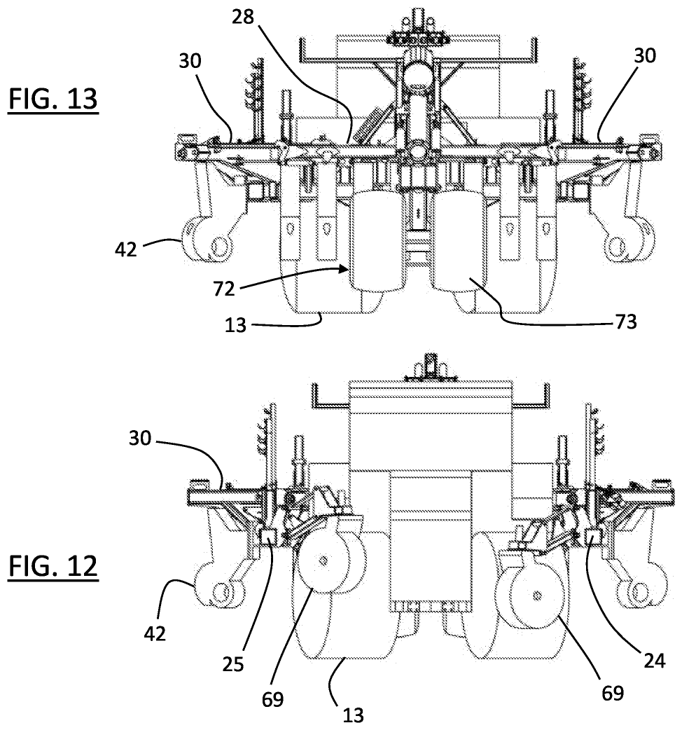

Furthermore, as shown in FIGS. 12-14, by mounting the center frame section 28 on a hitching member 17 of the towing vehicle which can be raised and lowered relative to its frame 2, such as a three-point hitch, the implement 20 can be raised above the ground surface. For transport, the implement 20 is preferably lifted from substantial engagement with the ground such that only the forward ground-engaging wheels 69 of the implement and the towing vehicle remain in contact with the ground surface (as demonstrated by the tool members 42 being disposed at a spaced height above bottoms of the traction elements 13), and with the wing sections 30 in the transport configuration, in which they are located further forwardly and closer to the towing vehicle 1 than in the working configuration, the center of mass of the coupled configuration is between the two rotational axes of the front and rear pairs of traction elements such that the towing vehicle has suitable traction for transport. The forward ground-engaging wheels 69 may assist in supporting the distal ends 24, 25 of the wing frame sections in spaced relation to the ground surface to avoid crashing into the ground if the towing vehicle momentarily leans to one side while traveling.

Although bottoms of the ground-engaging wheels 69 are shown in FIGS. 12-14 as being at spaced heights above the bottoms of the vehicle's traction elements, it is more practical to leave them in contact with the ground surface, as described above.

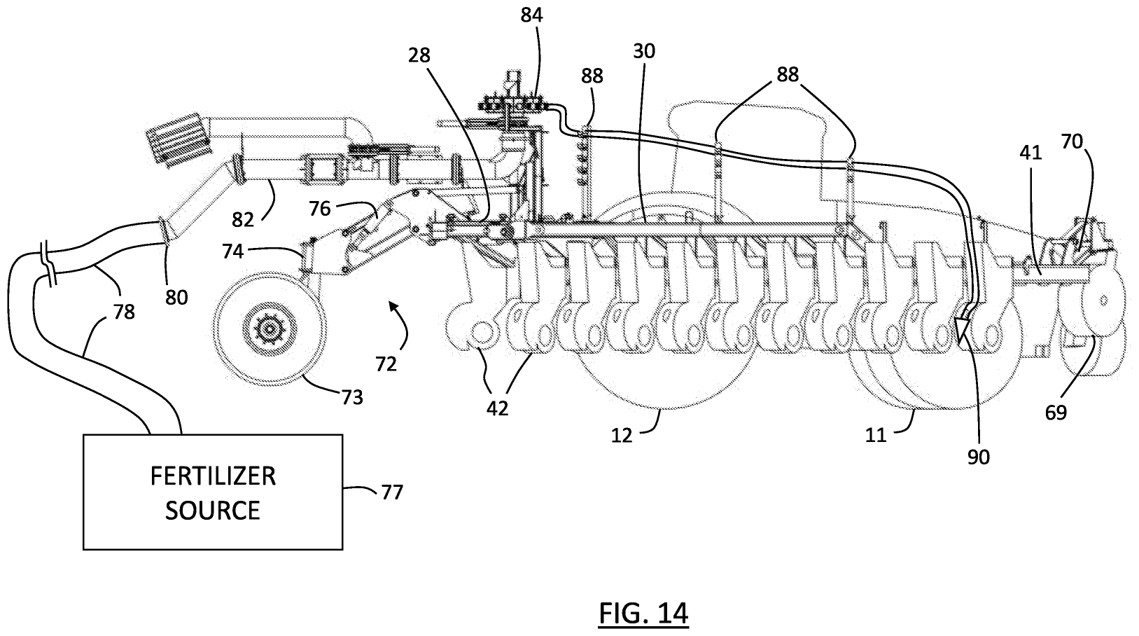

As shown in the figures, but with particular reference to FIG. 14, the implement 20 is a liquid fertilizer applicator configured for coupling to a fertilizer source 77, such as a tank containing liquid fertilizer, by a hose 78 trailing the implement. In this case, the center frame section 28 supports a hose inlet 80 configured for coupling to the hose at a height above the vehicle mounting member 31 of the center frame section which is located no higher than the lower beam 40. The hose inlet 80 is communicated with a pipe 82 which in turn is communicated with a manifold 84 to which a plurality of delivery hoses 86 are fluidically connected (only one is shown in FIG. 14 for clarity of illustration). Thus are provided hose hangers 88 of various heights at transversely spaced locations across the frame 22 to support the hoses 86 extending away from the manifold to opposite ends that are connected to and terminate at discharge nozzles 90 (only one shown in FIG. 14 for clarity of illustration). The nozzles 90 at transversely spaced locations across the frame sections 28, 30, which define soil working tool members of the fertilizer applicator, since discharging liquid fertilizer to the field acts to modify the soil.

In use of the agricultural implement 20, initially, it is mounted to the towing vehicle 1, usually a tractor, so as to be in trailing relation behind same. In other words, the implement 20 is hitched to the towing vehicle directly without any intermediate towed vehicles or trailers therebetween.

For transportation to the field to work the soil, the wing frame sections 30 of the vehicle-mounted or hitched implement 20 are folded forwardly and inwardly into the transport configuration, as shown in, for example, FIG. 6. Also, the implement 20 is positioned in a raised transport position relative to the towing vehicle (frame) so that no elements or members of the implement are in contact with the ground surface during transport, as for example shown in FIGS. 12-14. Typically, this means that lowest points or elements of the implement 20 are located at a spaced height, so as to be raised above, bottoms of the towing vehicle traction elements 13.

It will be appreciated that in the transport configuration of the illustrated arrangement of implement, the frame sections 28 and 30 generally form a CU′, with the wing frame sections 30 parallel to one another, on either side 9 or 10 of the towing vehicle, and substantially perpendicular to the center frame section 28. Also, this CU′ is leading in that opposite legs defined by the wing sections 30 extend forwardly from the center frame section 28 relative to the forward working direction or direction of travel FW.

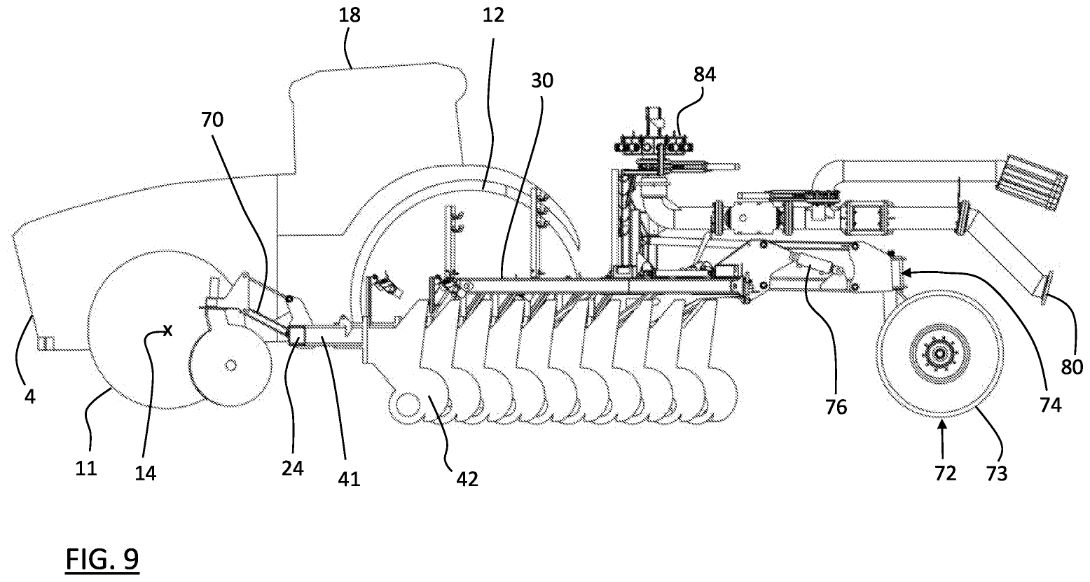

To conduct work in the field, the wing frame sections 30 of the vehicle-mounted or hitched implement 20 are folded rearwadly and outwardly from the transport configuration to the working configuration, as shown in, for example, FIG. 3. Also, the implement 20 is positioned in a lowered working position relative to the towing vehicle (frame) so that the tool members 42 are in contact with the ground surface, as shown in FIGS. 7-9. Typically, this means that bottoms of the tool members 42 are located below the bottoms of the towing vehicle traction elements 13.

Even when the wing frame sections 30 are in the working configuration, they are disposed to the sides 9, 10 of the towing vehicle, and not behind same. Thus, the center of mass of both the towing vehicle and coupled implement remains between the two rotational axes 14, 15 of the towing vehicle, and preferably as close to a longitudinal center of the towing vehicle as possible. The same is not achieved by towed agricultural implements which are in entirely trailing relation to the towing vehicle. In the case of the implement 20, only the center frame section 28 is wholly behind the towing vehicle, relative to the forward direction of movement FW, and the wing frame sections 30 are located substantially alongside the towing vehicle, notwithstanding being arranged in working or transport configurations.

It will be appreciated that in the working configuration of the illustrated arrangement of implement, the frame sections 28 and 30 generally form a V, symmetrical relative to the longitudinal axis 7, with each of the wing sections 30 extend longitudinally and transversely outwardly at a common angle from the center frame section 28. This V is leading in that the wing sections 30 extend longitudinally forwardly from the center frame section 28 relative to the forward working direction or direction of travel FW.

This arrangement of winged agricultural implement may be used with a towing vehicle, such as a tractor, that is smaller and has front wheel assist instead of a larger, more powerful unit with four wheel drive. Also, this arrangement of implement acts to transfer weight of the coupled configuration of towing vehicle with implement towards the front rotational axis of the vehicle, enhancing maneuverability. Furthermore, forward folding of the wing sections alongside the towing vehicle, so as to lead the center frame section, acts to reduce length of the implement behind the towing vehicle during transport, which may provide an opportunity to tow another implement or piece of equipment. Yet further, the wing sections located horizontally to the side of the towing vehicle may increase visibility to an operator of the towing vehicle, especially in the working configuration.

As described hereinbefore, the present invention relates to a towed winged agricultural implement comprising a center frame section arranged for mounting behind a towing vehicle relative to a forward direction of travel and a pair of wing frame sections having respective inner ends which are pivotally coupled at transversely opposite sides of the center frame section. The wing frame sections are movable relative to the center frame section between a working configuration extending forwardly and transversely outwardly in opposite directions from the center frame section, and a transport configuration extending forwardly from the center frame section to be parallel to the forward direction of travel and located adjacent the sides of the towing vehicle.

The scope of the claims should not be limited by the preferred embodiments set forth in the examples but should be given the broadest interpretation consistent with the specification as a whole.

1. A winged agricultural implement for towing in a forward working direction by a towing vehicle,
wherein the towing vehicle has a frame configured for movement across a ground surface,
wherein the frame has opposite front and rear ends along a longitudinal axis parallel to the forward working direction,
wherein the towing vehicle has transversely opposite sides, and
wherein the towing vehicle has front and rear pairs of traction elements rotatably supported on the frame and rotatable around longitudinally spaced front and rear rotational axes of the towing vehicle located in front of the rear end of the frame for supporting the frame in movement across the ground surface,
the implement comprising:
a center frame section arranged for mounting to the towing vehicle at the rear end thereof;
a pair of wing frame sections having respective inner ends which are pivotally coupled at transversely opposite sides of the center frame section; and
wherein the wing frame sections are movable relative to the center frame section between a working configuration extending forwardly and transversely outwardly in opposite directions from the center frame section, and a transport configuration extending forwardly from the center frame section to be parallel to the forward working direction and located adjacent the sides of the towing vehicle.

2. The winged agricultural implement of claim 1 wherein the center frame section is configured to span substantially a full width of the towing vehicle from one of the sides thereof to the other one thereof.

3. The winged agricultural implement of claim 1 wherein, in the working configuration, the wing frame sections are arranged to extend forwardly past the rear rotational axis of the towing vehicle.

4. The winged agricultural implement of claim 1 further including ground-engaging wheels rotatably coupled at respective distal ends of the wing frame sections that are opposite the respective inner ends thereof.

5. The winged agricultural implement of claim 4 wherein the ground-engaging wheels are supported for rotation around respective rotational axes arranged parallel to and rearwardly of the front rotational axis of the towing vehicle when the implement is arranged in the working configuration.

6. The winged agricultural implement of claim 4 wherein the wing frame sections each comprise a beam spanning between the respective inner and distal ends, and a corresponding one of the ground-engaging wheels is supported for rotation at a forwardly spaced location from the beam.

7. The winged agricultural implement of claim 4 wherein the ground-engaging wheels are supported for pivotal movement about respective vertical pivot axes for rollably engaging the ground surface in the working and transport configurations.

8. The winged agricultural implement of claim 1 wherein, in the transport configuration, the wing frame sections are arranged to be spaced from the sides of the towing vehicle.

9. The winged agricultural implement of claim 1 wherein the wing frame sections are pivotally movable relative to the center frame section about respective vertical pivot axes.

10. The winged agricultural implement of claim 1 further including first interlocking members on the respective inner ends of the wing frame sections configured for mating engagement, in the working configuration, with second interlocking members on the sides of the center frame section, and wherein the first interlocking members carry respective keeper pins and wherein the center frame section carries pivotal latch dogs configured to retain the keeper pins in the working configuration to secure the first interlocking members with the second interlocking members.

11. The winged agricultural implement of claim 10 wherein each first interlocking member is wedge-shaped with upwardly and downwardly facing walls.

12. The winged agricultural implement claim 10 wherein each second interlocking member comprises a receptacle with a V-shaped interior having vertically opposite inside walls.

13. The winged agricultural implement of claim 1 further including a ground-engaging wheel assembly rotatably coupled to the center frame section.

14. The winged agricultural implement of claim 13 wherein the ground-engaging wheel assembly comprises at least one wheel supported for rotation at a readwardly spaced location from the center frame section.

15. The winged agricultural implement of claim 13 wherein the ground-engaging wheel assembly is configured to be raised and lowered relative to the center frame section.

16. The winged agricultural implement of claim 1 further including a vehicle mounting member supported on the center frame section and configured for coupling to a three-point hitch.

17. The winged agricultural implement of claim 1 wherein the implement is a liquid fertilizer applicator configured for coupling to a fertilizer source by a hose trailing the implement.

18. A winged agricultural implement for towing in a forward working direction by a towing vehicle,
wherein the towing vehicle has a frame configured for movement across a ground surface,
wherein the frame has opposite front and rear ends along a longitudinal axis parallel to the forward working direction,
wherein the towing vehicle has transversely opposite sides, and
wherein the towing vehicle has front and rear pairs of traction elements rotatably supported on the frame and rotatable around longitudinally spaced front and rear rotational axes of the towing vehicle located in front of the rear end of the frame for supporting the frame in movement across the ground surface,
in combination with the towing vehicle, the implement comprising:
a center frame section mounted to the towing vehicle at the rear end thereof;
a pair of wing frame sections having respective inner ends which are pivotally coupled at transversely opposite sides of the center frame section; and
wherein the wing frame sections are movable relative to the center frame section between a working configuration extending forwardly and transversely outwardly in opposite directions from the center frame section, and a transport configuration extending forwardly from the center frame section to be parallel to the forward working direction and located adjacent the sides of the towing vehicle.
